(19) United States
(12) Patent Application Publication
(10) Pub. No.: US 2026/0066564 A1
(43) Pub. Date: Mar. 5, 2026

(54) ELECTRICAL CONNECTORS AND ASSOCIATED METHODS

(71) Applicant: LEAR CORPORATION, Southfield, MI (US)

(72) Inventors: Jordi Angel Serrano, Remscheid (DE); Xavier Farre Vives, Valls (ES); Antonio Garcia Izquierdo, Valls (ES); Joan Esteve Gomis Cano, Valls (ES)

(21) Appl. No.: 18/822,948

(22) Filed: Sep. 3, 2024

(51) Int. Cl. H01R 13/04; H01R 43/20

(52) U.S. Cl. CPC H01R 13/04; H01R 43/20

(57) ABSTRACT

An article may include a blade and a leg portion, the blade extending from the leg portion in a first direction, the leg portion may include a shelf providing a first width from a first lateral edge to a second lateral edge, a first rounded protrusion at the first lateral edge and spaced from the shelf in a second direction opposite the first direction, a second rounded protrusion at the second lateral edge, the first and second rounded protrusions each providing a curvature at the respective lateral edges with a radius and providing a second width greater than the first width, a first rounded indentation between the first rounded protrusion and the shelf, and a second rounded indentation between the second rounded protrusion and the shelf, the first and second rounded indentations each providing a curvature at the respective lateral edges with the radius.

### BACKGROUND

An electrical connector is an electromechanical device used to create an electrical connection between parts of an electrical circuit, or between different electrical circuits, thereby joining them into a larger circuit. A pin terminal is a type of electrical connector, which may be designed to join electrical wires to a terminal block, PCB, or other connection points.

### BRIEF DESCRIPTION OF THE DRAWINGS

FIG. 1 illustrates an example connector.

FIG. 2 illustrates a cross sectional view of the example connector received in an example header.

FIG. 3A illustrates an example leg portion of the example connector.

FIG. 3B illustrates the example leg portion of the example connector.

FIG. 4A illustrates a portion of the example connector.

FIG. 4B illustrates a portion of the example connector.

FIG. 5 illustrates a side view of the example connector.

FIG. 6 illustrates another example connector.

FIG. 7 illustrates another example connector.

FIG. 8 illustrates an example header receiving the example connectors.

FIG. 9 illustrates an example header receiving the example connectors.

FIG. 10 illustrates a spool of example connectors.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],”depending on the context.

It should be understood that terms such as “about,” “substantially,” and “generally” are not intended to be boundaryless terms, and should be interpreted consistent with the way one skilled in the art would interpret those terms.

This disclosure relates to electrical connectors and associate methods of forming and connecting the same. In some implementations, the electrical connectors may be pin terminals for insertion into slots in headers.

FIG. 1 illustrates an example article 20, namely an electrical connector, such as a pin terminal. The connector 20 includes a blade 22 extending from a leg portion 24 in a first direction D1.

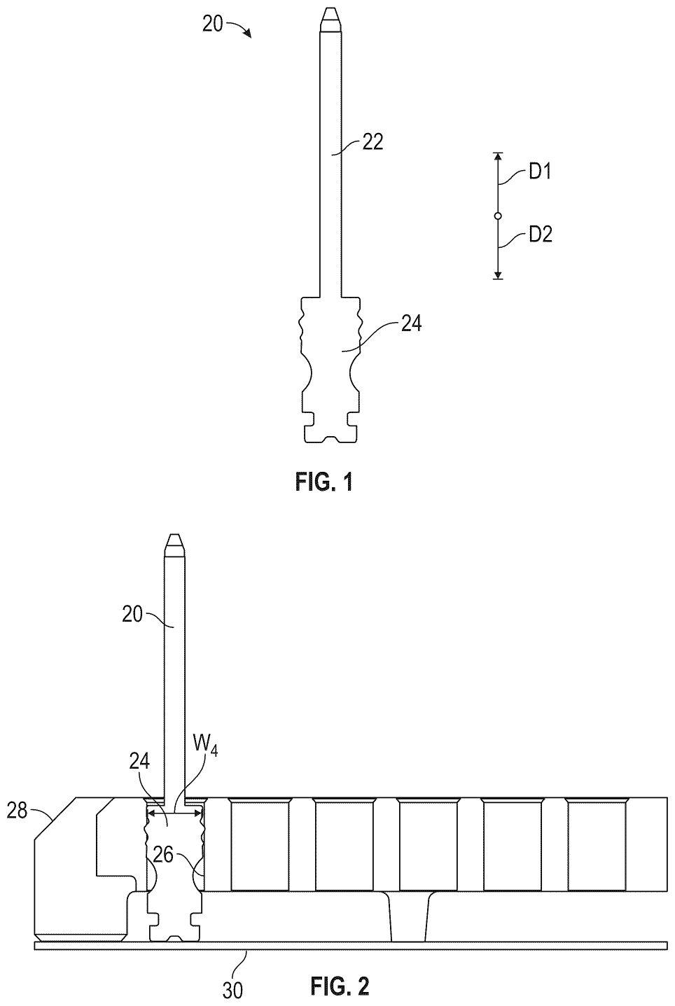

FIG. 2 illustrates the example connector 20 received in a slot 26 of a header 28, which may be received on a printed circuit board (“PCB”) 30. In some implementations, the header 28 may be plastic. In some implementations, the header 28 may be polymeric. In some implementations, the header 28 may be Liquid Crystal Polymer (LCP). In some implementations, the header 28 may be injection molded. At least part of the leg portion 24 may be received within the slot 26. The leg portion 24 may also be connected to the PCB 30. The blade 22 may extend away from the header 28 opposite the PCB 30. The blade 22 may provide an elongated electrical contact portion. In some implementations, the blade 22 and leg portion 24 may be a copper zinc alloy. In some implementations, the blade 22 and leg portion 24 may be CUZN30 brass, also known as C2600.

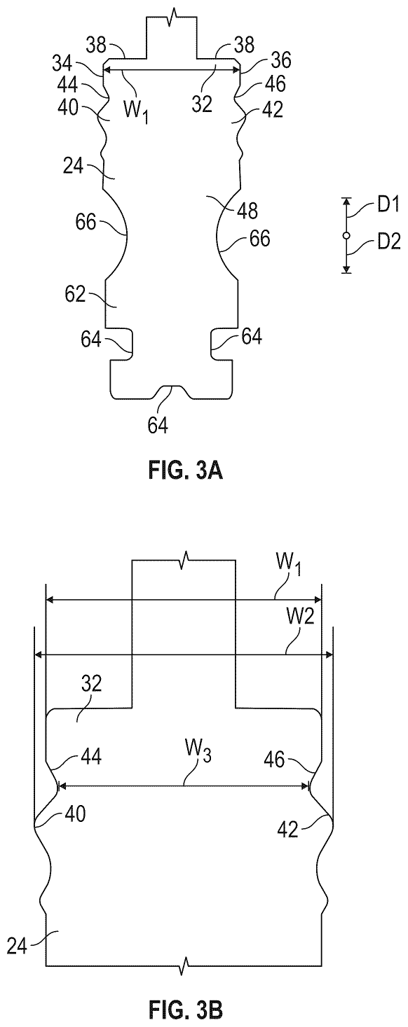

FIGS. 3A and 3B illustrate the example leg portion 24. The blade 22 extends from a shelf 32 that provides a first width w1 from a first lateral edge 34 to a second lateral edge 36. In some implementations, as shown, the shelf 32 provides an upper portion of the leg portion 24. The shelf includes upper edges 38 that extend from the blade 22. The lateral edges 34, 36 at the shelf 32 providing the width w1 may be substantially straight and substantially parallel (±5°) to one another and substantially perpendicular (±5°) to the upper edges 38. In some implementations, the first width w1 may be 1.74 mm (+0.05).

A first rounded protrusion 40 at the first lateral edge 34 is spaced from the shelf 32 in a second direction D2 opposite the first direction D1. A second rounded protrusion 42 is provided at the second lateral edge 36. The first and second rounded protrusions 40, 42 each provide a curvature at the respective lateral edges 34, 36 with a radius R. The first and second rounded protrusions 40, 42 each provide a second maximum width w2 greater than the first width w1. The widths w1 and w2 as shown are parallel to one another. In some implementations, the radius is 0.15 mm (+/−0.05). In some implementations, the width w2 is 1.87 mm (+0.05). The lateral edges 34, 36 at the respective first and second rounded protrusions 40, 42 may be convex as shown.

A first rounded indentation 44 is provided between the first rounded protrusion 40 and the shelf 32. A second rounded indentation 46 is provided between the second rounded protrusion 42 and the shelf 32. The first and second rounded indentations 44, 46 each providing a curvature at the respective lateral edges 34, 36 with the same radius R as the first and second rounded protrusions 40, 42. The lateral edges 34, 36 at the respective first and second rounded indentations 44, 46 may be concave as shown. The first rounded protrusion 40 and the first rounded indentation 44 may provide an S-shape at the lateral edge 34. The first rounded protrusion 42 and the first rounded indentation 46 may provide an S-shape at the lateral edge 36. The lateral edges 34, 36 at the respective first and second rounded indentations 44, 46 provide a third minimum width w3 less than the widths w1 and w2. The widths w1, w2, and w3 as shown are parallel to one another. The leg portion 24 spans the widths w1, w2, and w3 at the identified locations.

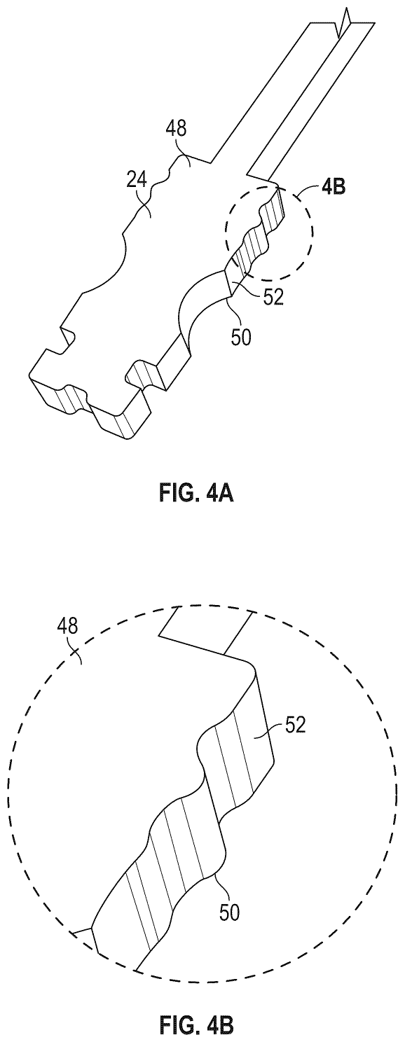

FIG. 3A illustrates a first face 48 of the example leg portion 24 providing the first and second lateral edges 34, 36. As shown in FIGS. 4A and 4B, the leg portion 24 includes a second face 50 opposite the first face 48, with a lateral surface 52 extending therebetween. As shown, the first face contour and the second face contour may be the same. The faces 48, 50 may have mirror symmetry. The faces 48, 50 may have mirrored outer contours.

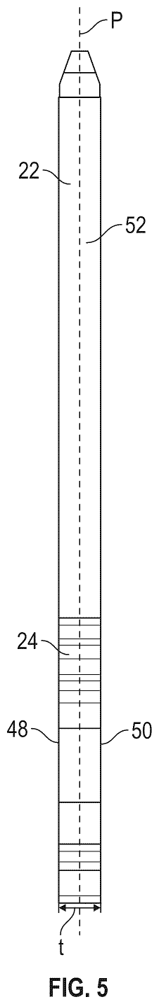

As shown in FIG. 5, a plane of symmetry P extends through the article and is parallel with the first face 48 and the second face 50. The faces 48, 50 have mirror symmetry across the plane of symmetry P. The lateral surface 52 provides a thickness t, and the blade 22 and the leg portion 24 have the same thickness t, except that a tip of the blade 22 may be tapered in some implementations.

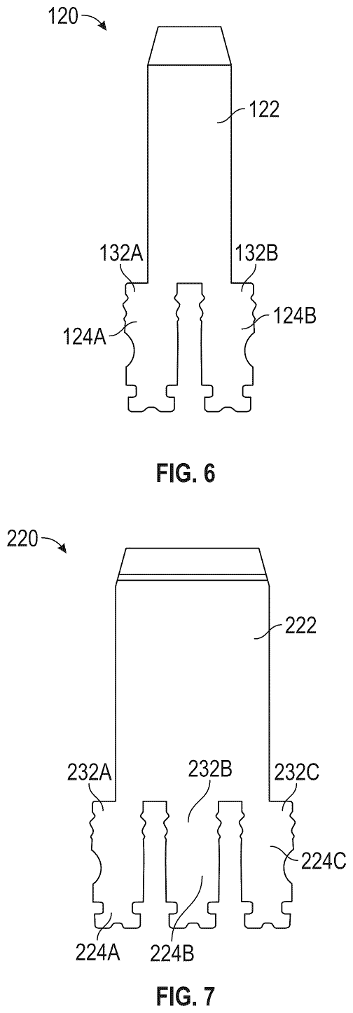

FIG. 6 illustrates an example connector 120 substantially similar to the connector 20, except that the example connector 120 includes two leg portions 124A, 124B. The blade 122 extends from the shelves 132A, 132B of the respective leg portions 124A, 124B. A shown, the leg portions 124A, 124B may have the same features, geometry, and/or dimensions as the leg portion 24.

FIG. 7 illustrates an example connector 220 substantially similar to the connectors 20 and 120, except that the example connector 220 includes three leg portions 224A, 224B, 224C. The blade 222 extends from the shelves 232A, 232B, 232C of the respective leg portions 224A, 224B. As shown, the leg portions 224A, 224B may have the same features, geometry, and/or dimensions as the leg portion 24.

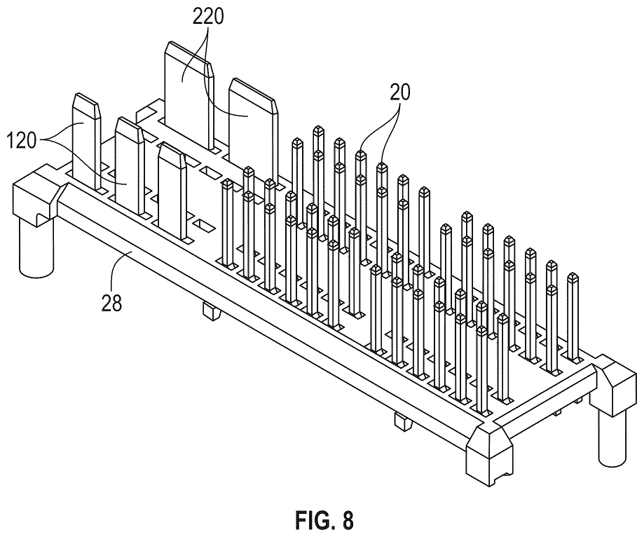

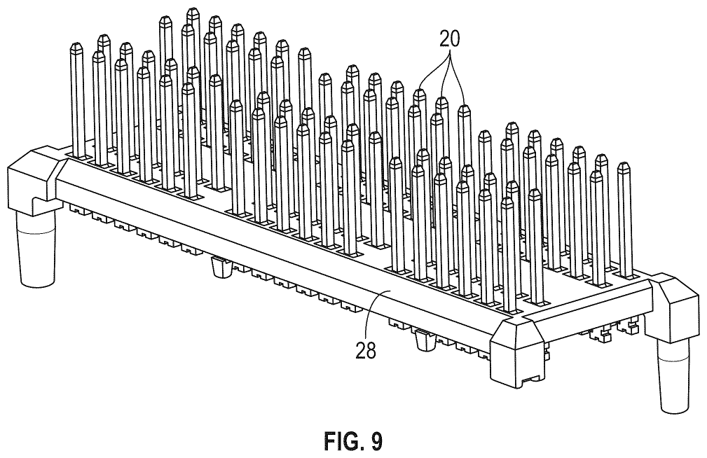

As shown in FIGS. 8 and 9, the header 28 may receive any number or combination of connectors 20, 120, 220 in its slots 26.

Referring back to FIG. 2, the slot 26 may have a width w4, spanning the same directions as the widths w1, w2, w3 when the connector 20 is received in the slot 26. The width w4 may be less than the width w2. In some implementations, referring also to FIGS. 3A and 3B, the first width w1 may be 1.74 mm (+0.05), the width w2 is 1.87 mm (+0.05), the radius R may be 0.15 mm (+/−0.05) mm, and the slot width w4 may be 1.75 mm (+/−0.02). The width w3 is less than the widths w1 and w2. The width w4 may be consistent along the slot 26, at least at the portions where the protrusions 40, 42, indentations 44, 46, and shelf 32 engage. The header 28 may be a plastic material and the leg portion 24 may be a copper zinc alloy. Applicant has found that this combination of geometry, dimensions, and material for the slot and leg portion has resulted in a retention force greater than or equal to 15 N in some implementations, which may result in reliable connections. The protrusions 40, 42 push the material of the header 28, while the indentations 44, 46 allow the pushed material to flow into the indentations, resulting in improved retention force. The indentations 44, 46 provide a recessed area between the protrusions 40, 42 and the shelf 30 into which the compressed header 28 material can flow when the leg portion 24 is received in the slot 26. The indentations 44, 46 and protrusions 40, 42 may be provided on both lateral sides so that resistance is even during insertion. The design may further provide the proper position in a stable and predictive production process.

Referring back to FIG. 3A, the leg portion 24 may include a lower section 62 spaced in the direction D2 from the protrusions 40, 42. The lower section 62 may engage the PCB 30 (see FIG. 2), such as through soldering, through hole, or surface mount connection. In some implementations, one or more voids 64 may be provided for solder paste to gather within. One or more punch indentations 66, such as from when multiple connectors 20 are separated after a stamping process.

An example method may include forming an article from flat sheet metal, the article including a blade and a leg portion, the blade extending from the leg portion in a first direction. The leg portion may include a shelf providing a first width from a first lateral edge to a second lateral edge, a first rounded protrusion at the first lateral edge and spaced from the shelf in a second direction opposite the first direction, a second rounded protrusion at the second lateral edge, the first and second rounded protrusions each providing a curvature at the respective lateral edges with a radius and providing a second width greater than the first width, a first rounded indentation between the first rounded protrusion and the shelf, and a second rounded indentation between the second rounded protrusion and the shelf, the first and second rounded indentations each providing a curvature at the respective lateral edges with the radius. In some implementations the forming may include a stamping process.

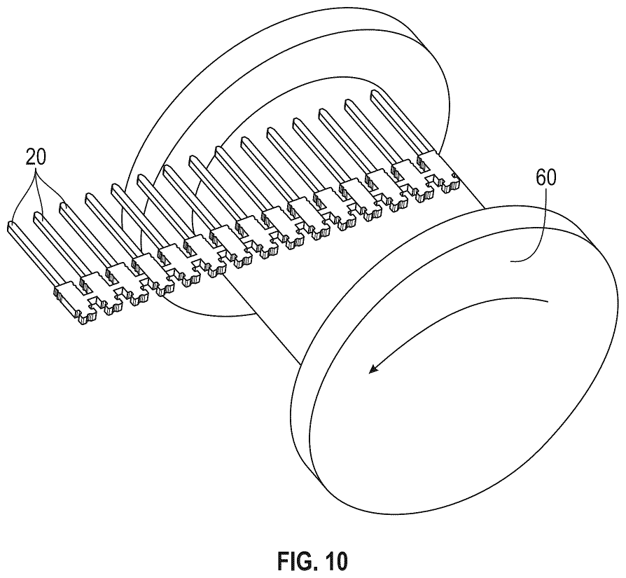

As shown in FIG. 10, multiple articles may be formed on a spool 60. The connector 20, including the blade 22 and leg portion 24, may be formed from a piece of flat sheet metal through a stamping process. The blade 22 and leg portion 24 may therefore have a uniform thickness. The blade 22 and leg portion 24 may be monolithic and formed from one piece of metal. Multiple connectors 20 may be formed from the same piece of metal.

An example method might involve forming an article from a flat sheet of metal, with the article featuring a blade and a leg portion. The blade extends from the leg portion in one direction. The leg portion includes a shelf that spans a first width from one lateral edge to the other. It also has a first rounded protrusion at the first lateral edge, positioned away from the shelf in the opposite direction, and a second rounded protrusion at the second lateral edge. Both rounded protrusions have a curvature with a radius and provide a second width that is larger than the first width. Additionally, there are first and second rounded indentations between each rounded protrusion and the shelf, each indentation having a curvature with the same radius as the protrusions. In some cases, the forming process may involve stamping.

An example method may include inserting an article into a slot in a header. The article may include a blade and a leg portion, the blade extending from the leg portion in a first direction. The leg portion may include a shelf providing a first width from a first lateral edge to a second lateral edge, a first rounded protrusion at the first lateral edge and spaced from the shelf in a second direction opposite the first direction, a second rounded protrusion at the second lateral edge, the first and second rounded protrusions each providing a curvature at the respective lateral edges with a radius and providing a second width greater than the first width, a first rounded indentation between the first rounded protrusion and the shelf, and a second rounded indentation between the second rounded protrusion and the shelf, the first and second rounded indentations each providing a curvature at the respective lateral edges with the radius. The slot may have a third width (e.g., 1.75 mm (+0.02)) less than the second width. In some implementations, the radius is 0.10-0.20 mm, the first width is 1.74-1.79 mm, the second width is 1.82-1.87 mm, and the third width is 1.73-1.77 mm, which Applicant has found such a combination results in a retention force greater than or equal to 15N.

The header may be received on a PCB. The article may be soldered to a PCB while received in the slot. The article may be connected to the PCB through through-hole technology or surface mount technology. In some implementations, the examples disclosed herein may be secured without the use of a retainer hook that engages the header.

In some implementations, the techniques described herein relate to an article, including: a blade; and a leg portion, the blade extending from the leg portion in a first direction, the leg portion including: a shelf providing a first width from a first lateral edge to a second lateral edge, a first rounded protrusion at the first lateral edge and spaced from the shelf in a second direction opposite the first direction, a second rounded protrusion at the second lateral edge, the first and second rounded protrusions each providing a curvature at the respective lateral edges with a radius and providing a second width greater than the first width, a first rounded indentation between the first rounded protrusion and the shelf, and a second rounded indentation between the second rounded protrusion and the shelf, the first and second rounded indentations each providing a curvature at the respective lateral edges with the radius.

The article may also include any of the following in any combination thereof.

In some implementations, the radius is 0.10-0.20 mm.

In some implementations, the first width is 1.74-1.79 mm, and the second width is 1.82-1.87 mm.

In some implementations, the leg portion includes a first face providing the first and second lateral edges and a second face adjoined to the first face by a lateral surface.

In some implementations, a plane of symmetry extends through the article and is parallel with the first face and the second face.

In some implementations, the lateral surface provides a thickness, and the blade and the leg portion have the same thickness.

In some implementations, the techniques described herein relate to an article, the blade extending in the first direction from a second leg portion, the second leg portion including: a second shelf providing the first width from a third lateral edge to a fourth lateral edge, a third rounded protrusion at the third lateral edge and spaced from the second shelf in the second direction, a fourth rounded protrusion at the fourth lateral edge, the third and fourth rounded protrusions each providing a curvature at the respective lateral edges with the radius providing the second width, a third rounded indentation between the third rounded protrusion and the second shelf, and a fourth rounded indentation between the fourth rounded protrusion and the second shelf, the third and fourth rounded indentations each providing a curvature at the respective third and fourth lateral edges with the radius.

In some implementations, the techniques described herein relate to an article, the blade extending in the first direction from a third leg portion, the third leg portion including: a third shelf providing the first width from a fifth lateral edge to a sixth lateral edge, a fifth rounded protrusion at the fifth lateral edge and spaced from the third shelf in the second direction, a sixth rounded protrusion at the sixth lateral edge, the fifth and sixth rounded protrusions each providing a curvature at the respective lateral edges with the radius and providing the second width, a fifth rounded indentation between the fifth rounded protrusion and the third shelf, and a sixth rounded indentation between the sixth rounded protrusion and the third shelf, the fifth and sixth rounded indentations each providing a curvature at the respective fifth and sixth lateral edges with the radius.

In some implementations, the techniques described herein relate to a method, including: forming an article from flat sheet metal, the article including: a blade; and a leg portion, the blade extending from the leg portion in a first direction, the leg portion including: a shelf providing a first width from a first lateral edge to a second lateral edge, a first rounded protrusion at the first lateral edge and spaced from the shelf in a second direction opposite the first direction, a second rounded protrusion at the second lateral edge, the first and second rounded protrusions each providing a curvature at the respective lateral edges with a radius and providing a second width greater than the first width, a first rounded indentation between the first rounded protrusion and the shelf, and a second rounded indentation between the second rounded protrusion and the shelf, the first and second rounded indentations each providing a curvature at the respective lateral edges with the radius.

The method may also include the following. In some implementations, the radius is 0.10-0.20 mm. In some implementations, the first width is 1.74-1.79 mm, and the second width is 1.82-1.87 mm.

In some implementations, the techniques described herein relate to a method, including: inserting an article into a slot in a header, the article including: a blade; and a leg portion, the blade extending from the leg portion in a first direction, the leg portion including: a shelf providing a first width from a first lateral edge to a second lateral edge, a first rounded protrusion at the first lateral edge and spaced from the shelf in a second direction opposite the first direction, a second rounded protrusion at the second lateral edge, the first and second rounded protrusions each providing a curvature at the respective lateral edges with a radius and providing a second width greater than the first width, a first rounded indentation between the first rounded protrusion and the shelf, and a second rounded indentation between the second rounded protrusion and the shelf, the first and second rounded indentations each providing a curvature at the respective lateral edges with the radius, wherein the slot has a third width less than the second width.

The method may also include the following. In some implementations, the radius is 0.10-0.20 mm. In some implementations, the first width is 1.74-1.79 mm, and the second width is 1.82-1.87 mm. In some implementations, the third width is 1.73-1.77 mm. In some implementations, the first width is 1.74-1.79 mm, the second width is 1.82-1.87 mm, and the third width is 1.73-1.77 mm. In some implementations, the header is LCP, and the article includes a copper zinc alloy. In some implementations, the leg portion includes a first face providing the first and second lateral edges and a second face adjoined to the first face by a lateral surface. In some implementations, a plane of symmetry extends through the article and is parallel with the first face and the second face.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An article, comprising:
a blade; and
a leg portion, the blade extending from the leg portion in a first direction, the leg portion including:
a shelf providing a first width from a first lateral edge to a second lateral edge,
a first rounded protrusion at the first lateral edge and spaced from the shelf in a second direction opposite the first direction,
a second rounded protrusion at the second lateral edge, the first and second rounded protrusions each providing a curvature at the respective lateral edges with a radius and providing a second width greater than the first width,
a first rounded indentation between the first rounded protrusion and the shelf, and
a second rounded indentation between the second rounded protrusion and the shelf, the first and second rounded indentations each providing a curvature at the respective lateral edges with the radius.

2. The article of claim 1, wherein the radius is 0.10-0.20 mm.

3. The article of claim 2, wherein the first width is 1.74-1.79 mm, and the second width is 1.82-1.87 mm.

4. The article of claim 1, wherein the leg portion includes a first face providing the first and second lateral edges and a second face adjoined to the first face by a lateral surface.

5. The article of claim 4, wherein a plane of symmetry extends through the article and is parallel with the first face and the second face.

6. The article of claim 5, wherein the lateral surface provides a thickness, and the blade and the leg portion have the thickness.

7. The article of claim 1, the blade extending in the first direction from a second leg portion, the second leg portion comprising:
a second shelf providing the first width from a third lateral edge to a fourth lateral edge,
a third rounded protrusion at the third lateral edge and spaced from the second shelf in the second direction,
a fourth rounded protrusion at the fourth lateral edge, the third and fourth rounded protrusions each providing a curvature at the respective lateral edges with the radius providing the second width,
a third rounded indentation between the third rounded protrusion and the second shelf, and
a fourth rounded indentation between the fourth rounded protrusion and the second shelf, the third and fourth rounded indentations each providing a curvature at the respective third and fourth lateral edges with the radius.

8. The article of claim 7, the blade extending in the first direction from a third leg portion, the third leg portion comprising:
a third shelf providing the first width from a fifth lateral edge to a sixth lateral edge,
a fifth rounded protrusion at the fifth lateral edge and spaced from the third shelf in the second direction,
a sixth rounded protrusion at the sixth lateral edge, the fifth and sixth rounded protrusions each providing a curvature at the respective lateral edges with the radius and providing the second width,
a fifth rounded indentation between the fifth rounded protrusion and the third shelf, and
a sixth rounded indentation between the sixth rounded protrusion and the third shelf, the fifth and sixth rounded indentations each providing a curvature at the respective fifth and sixth lateral edges with the radius.

9. A method, comprising:
forming an article from flat sheet metal, the article comprising:
a blade; and
a leg portion, the blade extending from the leg portion in a first direction, the leg portion including:
a shelf providing a first width from a first lateral edge to a second lateral edge,
a first rounded protrusion at the first lateral edge and spaced from the shelf in a second direction opposite the first direction,
a second rounded protrusion at the second lateral edge, the first and second rounded protrusions each providing a curvature at the respective lateral edges with a radius and providing a second width greater than the first width,
a first rounded indentation between the first rounded protrusion and the shelf, and
a second rounded indentation between the second rounded protrusion and the shelf, the first and second rounded indentations each providing a curvature at the respective lateral edges with the radius.

10. The method of claim 9, wherein the radius is 0.10-0.20 mm.

11. The method of claim 10, wherein the first width is 1.74-1.79 mm, and the second width is 1.82-1.87 mm.

12. A method, comprising:
inserting an article into a slot in a header, the article comprising:
a blade; and
a leg portion, the blade extending from the leg portion in a first direction, the leg portion including:
a shelf providing a first width from a first lateral edge to a second lateral edge,
a first rounded protrusion at the first lateral edge and spaced from the shelf in a second direction opposite the first direction,
a second rounded protrusion at the second lateral edge, the first and second rounded protrusions each providing a curvature at the respective lateral edges with a radius and providing a second width greater than the first width,
a first rounded indentation between the first rounded protrusion and the shelf, and
a second rounded indentation between the second rounded protrusion and the shelf, the first and second rounded indentations each providing a curvature at the respective lateral edges with the radius,
wherein the slot has a third width less than the second width.

13. The method of claim 12, wherein the radius is 0.10-0.20 mm.

14. The method of claim 13, wherein the first width is 1.74-1.79 mm, and the second width is 1.82-1.87 mm.

15. The method of claim 14, wherein the third width is 1.73-1.77 mm.

16. The method of claim 12, wherein the first width is 1.74-1.79 mm, the second width is 1.82-1.87 mm, and the third width is 1.73-1.77 mm.

17. The method of claim 16, wherein the header comprises Liquid Crystal Polymer, and the article comprises a copper zinc alloy.

18. The method of claim 12, wherein the header comprises Liquid Crystal Polymer, and the article comprises a copper zinc alloy.

19. The method of claim 12, wherein the leg portion includes a first face providing the first and second lateral edges and a second face adjoined to the first face by a lateral surface.

20. The method of claim 19, wherein a plane of symmetry extends through the article and is parallel with the first face and the second face.
